(19) United States
(12) Patent Application Publication
(10) Pub. No.: US 2011/0226595 A1
(43) Pub. Date: Sep. 22, 2011

(54) ILLUMINATION TYPE KEY SHEET AND PUSH BUTTON SWITCH

(76) Inventors: Masami Arai, Tokyo (JP); Tohru Kimura, Tokyo (JP)

(21) Appl. No.: 13/131,075

(22) PCT Filed: Nov. 25, 2009
(86) PCT No.: PCT/JP2009/069832

§ 371 Date: May 25, 2011

(30) Foreign Application Priority Data
Nov. 26, 2008 (JP) 2008-301610

(51) Int. Cl. H01H 13/50; F21V 8/00

(52) U.S. Cl. 200/314; 362/97.1

(57) ABSTRACT

The present invention provides a technique that can divide and illuminate display elements juxtaposed in one key top for each use function. Areas divided by the dividing portions of the attenuation means in the projection surface of the key top can be respectively illuminated by backlights from different LEDs, so each divided area can be individually controlled and illuminated. Therefore, it is possible to realize a key sheet in which display elements juxtaposed in one key top are divided for each use function and illuminated.

### TECHNICAL FIELD

The present invention relates to an illumination type key sheet and a push button switch which is used for an operation unit of various electronic devices such as a mobile information terminal device, a PDA, an AV device, various remote controls, and various keyboards, and can be illuminated by light (backlight) of light source mounted inside of an electronic device.

### BACKGROUND ART

A plurality of key tops that receive a pressing operation are provided in a key sheet of various electronic devices such as a mobile information terminal device and an AV device, and there are many key tops whose display elements such as characters and symbols are illuminated by backlight in order to improve operability in a dark place. Light-emitting diode (LED) is used as an example of a light source of the backlight.

The design of such a key sheet is diversified. For example, Japanese Unexamined Patent Application Publication No. 2008-41431 discloses a technique for dividing a key sheet into a plurality of areas, illuminating each area by one of LEDs emitting lights whose colors are different from each other, and differentiating the color of illumination of each area. By doing so, it is possible to illuminate a key top group used for a pressing operation of one function with the same color, so there is an advantage of improving operability.

### CITATION LIST

### Patent Literature

PTL 1: Japanese Unexamined Patent Application Publication No. 2008-41431

### SUMMARY OF INVENTION

### Technical Problem

By the way, as electronic devices are multi-functionalized, a plurality of types of display elements are often arranged in one key top. For example, in a key top of a mobile phone, “number” used for communication function and “character” used for mail function are juxtaposed and displayed in one key top. In PTL 1, although key top groups used for use functions can be divided by color, there is a problem that display elements juxtaposed and displayed in one key top cannot be divided and displayed for each use function. In the above example, it is not possible to illuminate only “number” used for communication function or illuminate only “character” used for mail function.

The present invention is made based on the background of the above-described conventional technique. Therefore, an object of the present invention is to provide a technique that can divide and illuminate display elements juxtaposed in one key top for each use function.

### Solution to Problem

To achieve the above object, the present invention provides an illumination type key sheet which includes a base sheet formed of a light guiding sheet and light-transparent key tops firmly fixed to an operation surface side of the base sheet and in which a display element showing an operation function of a key top can be illuminated by backlight, wherein the base sheet is a light guiding sheet which includes a light guiding means for transmitting light and an attenuation means for attenuating or reflecting light and in which the attenuation means divides the light guiding means into a plurality of illumination areas for transmitting light, and a plurality of display elements showing a plurality of operation functions included in one key top are illuminated from an illumination area corresponding to each display element.

In the present invention, the base sheet is a light guiding sheet which includes a light guiding means for transmitting light and an attenuation means for attenuating or reflecting light and in which the attenuation means divides the light guiding means into a plurality of illumination areas for transmitting light. Since the base sheet is a light guiding sheet which includes a light guiding means for transmitting light and an attenuation means for attenuating or reflecting light and in which the attenuation means divides the light guiding means into a plurality of illumination areas for transmitting light, the light guiding sheet is divided into a plurality of illumination areas by the attenuation means provided in the light guiding sheet.

A plurality of display elements showing a plurality of operation functions included in one key top are illuminated from an illumination area corresponding to each display element. Since a plurality of display elements showing a plurality of operation functions included in one key top are illuminated from an illumination area corresponding to each display element, it is possible to individually illuminate each of the plurality of display elements included in one key top, which are number and alphabet letters.

The attenuation means divides a key top according to a plurality of illumination areas and the attenuation means can divide the illumination area along a light emitting direction from a light source. Since the attenuation means divides a key top according to a plurality of illumination areas and the attenuation means divides the illumination area along a light emitting direction from a light source, it is possible to divide a key top into a plurality of areas and individually illuminate each area.

“Along a light emitting direction from a light source” means not only the light emitting direction from the light source, but also approximately the same direction as the light emitting direction, and includes a range which can be illuminated by direct light from an internal light source. By doing so, it is possible to make it difficult to block the backlight transmitted in the light guiding means by the attenuation means, and thus, the light guiding efficiency can be enhanced.

The light guiding means is a portion that contributes to light guidance in the light guiding sheet, and can be formed of a rubber-like elastic body or a resin. If the light guiding means is formed of a rubber-like elastic body or a flexible resin, the light guiding means can be a base sheet that can be elastically deformed, so it is possible to achieve an operational feeling of pressing corresponding to the elastic deformation when a pressing operation is performed. If a diffusion layer is provided on the light guiding means, it is possible to make it easy to input the backlight transmitted in the light guiding means into the key top.

The attenuation means is a portion that attenuates or reflects light in the light guiding sheet, and this portion can also be formed of a rubber-like elastic body. Further, the portion can be formed by a notch portion of the light guiding sheet, in other words, a space such as a slit.

If the attenuation means is formed of a rubber-like elastic body, the attenuation means can be elastically deformed, so it is possible to enhance pressing operability when a pressing operation is performed.

If the attenuation means is formed of a space, it is possible to reflect and attenuate the light transmitted in the light guiding means by the interface between the light guiding means and the space. Therefore, it is possible to make it difficult to transmit the light transmitted in the light guiding means to a light guiding means across the space, so that it is possible to illuminate the key top for each area divided by the space. In addition, the weight of the base sheet can be lightened. If a hollow attenuation means is provided between key tops adjacent to each other, when a pressing operation is performed, the attenuation means can insulate the stress to the adjacent key top, so it is possible to make it difficult for the adjacent key tops to operate together.

If the attenuation means is formed of a rubber-like elastic body or the like, the attenuation means can be formed to be solid. If the attenuation means is formed to be solid as described above, the rigidity of the base sheet can be increased, and the key sheet is easily manufactured and easily mounted in an electronic device.

Further, if the elastic moduli of the light guiding means formed of a rubber-like elastic body and the attenuation means, both of which are formed of a rubber-like elastic body, are set to the same value, the base sheet can be elastically deformed uniformly, so it is possible to improve the operational feeling of pressing as well as realize a correct pressing operation.

A transparent resin film can be provided on the operation surface side of the base sheet. By doing so, the key tops are firmly fixed to the resin film provided on the operation surface side of the base sheet, so the key tops and the base sheet can be strongly fixed to each other without being influenced by the materials of the light guiding means and the attenuation means. The display elements and the diffusion layers can be formed by printing on the resin film, so the display elements and the diffusion layers can be easily provided on the base sheet.

When manufacturing the base sheet, if the attenuation means is provided after the light guiding means is provided on the resin film, it is possible to prevent the attenuation means from covering the operation surface side of the light guiding means, and thus the base sheet can be easily obtained.

A blindfold portion covering the attenuation means can be provided on the operation surface side of the base sheet. The edge surface of the light guiding means in which light is transmitted may be seen brightly, and when an attenuation means is provided on a projection surface of a key top on the back surface side of the light-transparent key top as in the present invention, an interface between the attenuation means and the light guiding means may be seen brightly through the key top. However, if a blindfold portion that covers the attenuation means is provided on the operation surface side of the base sheet, it is possible to make it difficult to see the interface between the attenuation means and the light guiding means through the key top, and thereby the appearance of the key top when illuminated can be improved.

A light color layer can be provided between the light guiding means and the attenuation means. The attenuation means blocks and attenuates light, so if the light guiding means and the attenuation means are in contact with each other, the light guiding efficiency of the backlight may decrease. However, if a light color layer is provided between the light guiding means and the attenuation means, it is possible to make it more difficult for the light color layer than for the attenuation means to absorb light, and thus, the light guiding efficiency can be enhanced. The light color layer is a layer having a bright tone, and includes a white layer and a metallic tone layer.

A resin layer can be provided between the light guiding means and the attenuation means. By doing so, the rigidity of the base sheet can be increased, and the key sheet is easily manufactured and easily mounted in an electronic device.

When manufacturing the base sheet, the light guiding means and the attenuation means are formed with the resin film in between, so it is possible to prevent the attenuation means from covering the operation surface side of the light guiding means, or prevent the light guiding means from covering the operation surface side of the attenuation means, and thus the base sheet can be easily obtained.

The attenuation means can be a light reflecting layer. The light transmitted in the light guiding means is reflected by the light reflecting layer and attenuates. Therefore, it is possible to make it difficult to transmit the light transmitted in the light guiding means to a light guiding means across the light reflecting layer, so that it is possible to illuminate the key top for each area divided by the light reflecting layer.

The interface of the attenuation means formed in the thickness direction of the base sheet with the light guiding means can face the back surface side opposite to the operation surface side of the base sheet. The interface between the attenuation means and the light guiding means may be seen brightly through a pressing operation portion. However, if the interface of the attenuation means with the light guiding means faces the back surface side of the base sheet, it is possible to make it difficult to see the interface between the attenuation means and the light guiding means through the pressing operation portion, and thereby the appearance of the key top when illuminated can be improved.

If the attenuation means is formed of a rubber-like elastic body or the like, the attenuation means can form the outer edges of the base sheet. By doing so, it is possible to make it difficult for the backlight transmitted in the light guiding means of the base sheet to leak from the outer edges of the base sheet, and thus, the light guiding efficiency can be enhanced.

If the attenuation means is formed of a rubber-like elastic body or the like, the attenuation means can form the back surface of the base sheet. By doing so, it is possible to make it difficult for the backlight transmitted in the light guiding means of the base sheet to leak from the back surface of the base sheet, and thus, the light guiding efficiency can be enhanced. When the light guiding means is formed of a rubber-like elastic body, if the display elements are formed by the diffusion layers provided on the light guiding means, the attenuation means that forms the back surface of the base sheet may be the background of the display elements.

Also, the present invention provides a push button switch including an illumination type key sheet which includes a base sheet formed of a light guiding sheet and light-transparent key tops firmly fixed to an operation surface side of the base sheet and in which a display element showing an operation function of a key top can be illuminated by backlight and a circuit board having a plurality of internal light sources, wherein the base sheet is a light guiding sheet which includes a light guiding means for transmitting light and an attenuation means for attenuating or reflecting light and in which the attenuation means divides the light guiding means into a plurality of illumination areas for transmitting light, and a plurality of display elements showing a plurality of operation functions included in one key top are illuminated from an illumination area corresponding to each display element.

In the push button switch of the present invention, the base sheet includes the attenuation means that divides the projection surface of the key top into a plurality of areas, and light emitted from the internal light sources different for each divided area of the projection surface is transmitted to each divided area of the key top by the light guiding means. Thus, the areas divided by the attenuation means on the projection surface of the key top can be respectively illuminated by the light emitted from the different internal light sources, so the illumination of each divided area can be individually controlled.

### Advantages Effects of Invention

According to the illumination type key sheet and the push button switch of the present invention, areas divided by the attenuation means on the projection surface of the key top can be respectively illuminated by different backlights, so the illumination of each divided area can be individually controlled. Therefore, it is possible to realize an illumination type key sheet and a push button switch in which display elements juxtaposed in one key top are divided for each use function and illuminated.

### BRIEF DESCRIPTION OF DRAWINGS

FIG. 1 is an illustration showing display elements that can be seen when illuminated in a key sheet of a first embodiment.

FIG. 2 is an illustration showing display elements that can be seen when illuminated in another way in the key sheet of the first embodiment.

FIG. 3 is a disassembled view of the key sheet of the first embodiment, a partial view (A) is a plan view of a top cover, a partial view (B) is a plan view of key tops, a partial view (C) is a plan view of a base sheet, and a partial view (D) is a plan view of a pusher sheet.

FIG. 4 is a cross-sectional view taken along IV-IV line in FIG. 1.

FIG. 5 is an enlarged illustration of a push button switch including the key sheet of the first embodiment.

FIG. 6 is a cross-sectional view taken along VI-VI line in FIG. 5.

FIG. 7 is a cross-sectional view corresponding to FIG. 4 showing a first modification example of the key sheet of the first embodiment.

FIG. 8 is a cross-sectional view corresponding to FIG. 4 showing a second modification example of the key sheet of the first embodiment.

FIG. 9 is a cross-sectional view corresponding to FIG. 4 showing a key sheet of a second embodiment.

FIG. 10 is a cross-sectional view corresponding to FIG. 4 showing a key sheet of a third embodiment.

FIG. 11 is a cross-sectional view corresponding to FIG. 4 showing a key sheet of a fourth embodiment.

FIG. 12 is a cross-sectional view corresponding to FIG. 4 showing a modification example of the key sheet of the fourth embodiment.

FIG. 13 is a cross-sectional view corresponding to FIG. 4 showing a key sheet of a fifth embodiment.

FIG. 14 is an illustration showing a manufacturing process of the key sheet of the fifth embodiment.

FIG. 15 is a cross-sectional view corresponding to FIG. 4 showing a key sheet of a sixth embodiment.

FIG. 16 is a cross-sectional view corresponding to FIG. 4 showing a key sheet of a seventh embodiment.

FIG. 17 is a cross-sectional view corresponding to FIG. 4 showing a key sheet of an eighth embodiment.

FIG. 18 is a plan view of a base sheet used in the key sheet of the eighth embodiment.

FIG. 19 is a cross-sectional view corresponding to FIG. 4 showing a modification example of the key sheet of the eighth embodiment.

FIG. 20 is a cross-sectional view corresponding to FIG. 4 showing a key sheet of a ninth embodiment.

FIG. 21 is a cross-sectional view corresponding to FIG. 4 showing a first modification example of the key sheet of the ninth embodiment.

FIG. 22 is a cross-sectional view corresponding to FIG. 4 showing a second modification example of the key sheet of the ninth embodiment.

FIG. 23 is a cross-sectional view corresponding to FIG. 4 showing a modification example common to the key sheets of each embodiment.

FIG. 24 is a cross-sectional view corresponding to FIG. 5 showing another modification example common to the key sheets of each embodiment.

### DESCRIPTION OF EMBODIMENTS

Hereinafter, embodiments of the present invention will be described with reference to the drawings. An example will be described in which an illumination type key sheet (hereinafter abbreviated as “key sheet”) of the present invention is applied to a mobile phone as an “electronic device”. Components common to the embodiments will be given the same reference characters and redundant description will be omitted.

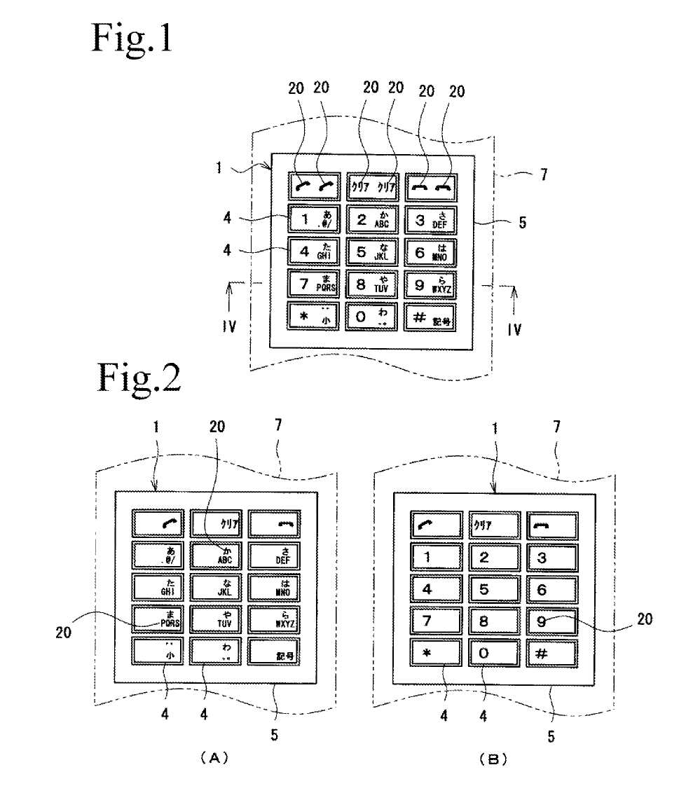

### First Embodiment [FIG. 1 to FIG. 6]

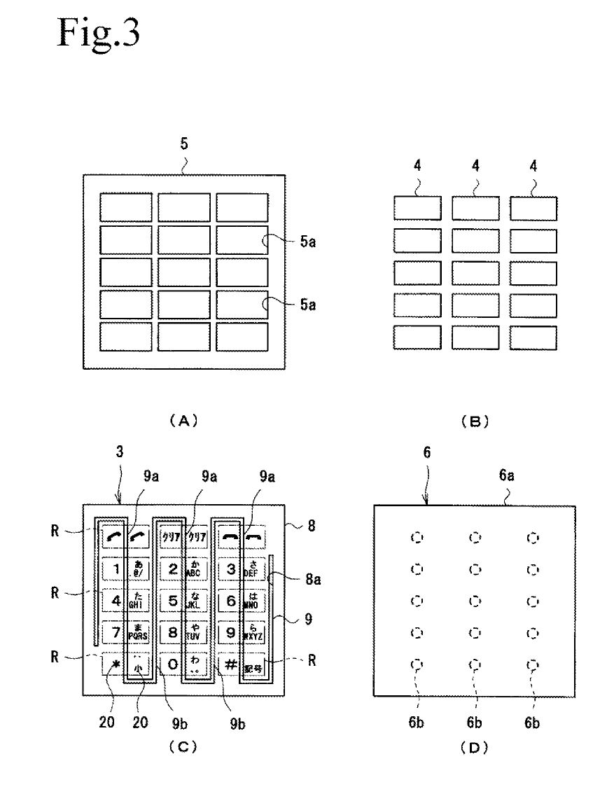

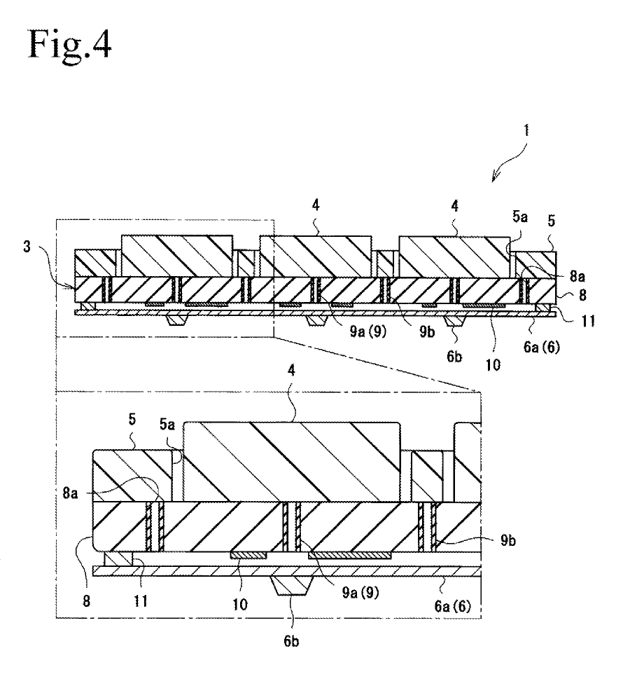

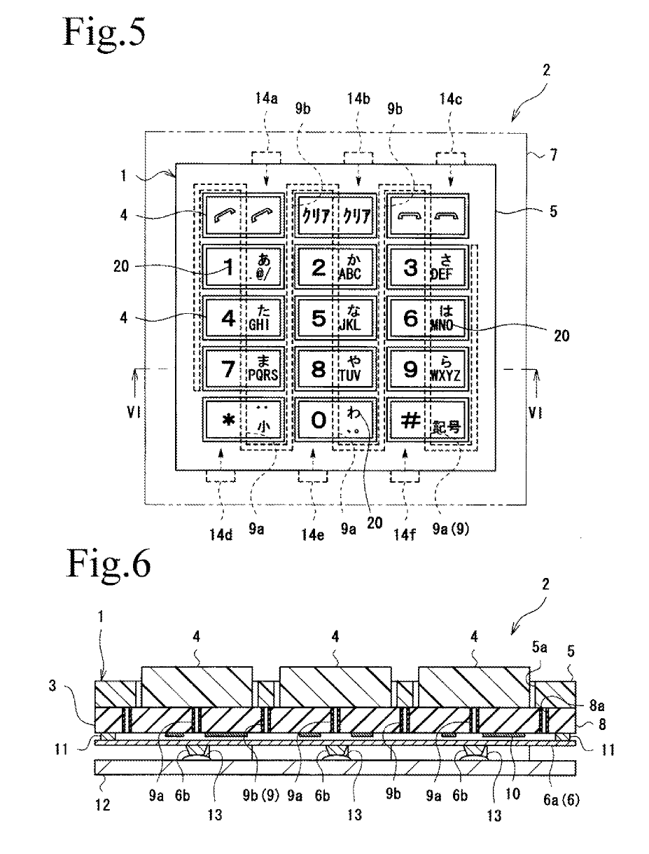

FIGS. 1 to 4 show a key sheet 1 of the first embodiment. FIGS. 4 and 6 show a push button switch 2 including the key sheet 1. FIG. 1 shows a plan view of the key sheet 1 when illuminated. FIG. 2 shows a plan view of the key sheet 1 when illuminated in another way. FIG. 3 shows a disassembled plan view of the key sheet 1. FIG. 4 shows a cross-sectional view of the key sheet 1. FIG. 5 shows an enlarged illustration of the push button switch 2. FIG. 6 shows an enlarged cross-sectional view of the push button switch 2. The key sheet 1 of the first embodiment includes a base sheet 3, key tops 4, a top cover 5, and a pusher sheet 6.

The base sheet 3 is formed of a light guiding means 8 formed of a rubber-like elastic body and an attenuation means 9 formed of a rubber-like elastic body.

The light guiding means 8 is a base material of the base sheet 3. The light guiding means 8 is a transparent portion which guides light. The surface of the light guiding means 8 is a flat and smooth surface. As shown in FIG. 3 (C), a through hole 8a is formed which meanders in a square wave shape in a plan view. A diffusion layer 10 is provided at a position corresponding to a projection surface R of the key top 4 on the back surface opposite to an operation surface of the light guiding means 8. The diffusion layer 10 is formed into shapes of display elements 20 which represent hiraganas, katakanas, alphabets, symbols, and the like.

As shown in FIG. 3 (C), the attenuation means 9 is formed in the through hole 8a of the light guiding means 8 and includes dividing portions 9a which divide the projection surface R of one key top 4 into a left half and a right half and partition portions 9b which divide the entire projection surfaces R of the key tops 4 into vertical columns. Further, as shown in FIG. 4, the attenuation means 9 is formed into a hollow shape. Specifically, the attenuation means 9 is provided in film form on wall surfaces of the through hole 8a facing each other without filling the through hole 8a.

As material used for the light guiding means 8 of the base sheet 3, a transparent thermoplastic resin and curable resin are used in addition to the transparent rubber-like elastic body. Examples of the rubber-like elastic body include a silicone rubber, an ethylene propylene rubber, a butadiene rubber, a styrene based thermoplastic elastomer, a urethane based thermoplastic elastomer, an olefinic thermoplastic elastomer, an acrylic thermoplastic elastomer, a polyester based thermoplastic elastomer, a polyamide based thermoplastic elastomer, and the like. Among them, a highly transparent silicone rubber, urethane based thermoplastic elastomer, and acrylic thermoplastic elastomer are preferable. Examples of the thermoplastic resin and the curable resin include a polyethylene resin, a polypropylene resin, a polycarbonate resin, a polyethylene terephthalate resin, a polybutylene terephthalate resin, an acrylic resin, a polyamide resin, a polyurethane resin, and the like. Among them, a highly transparent polycarbonate resin and acrylic resin are preferable.

As material used for the attenuation means 9 of the base sheet 3, a paint made from a rubber-like elastic body containing pigment and a resin, or a curable resin containing pigment is used. Among them, if the same material as that of the light guiding means 8, such as a silicone rubber, an ethylene propylene rubber, a butadiene rubber, a styrene based thermoplastic elastomer, a urethane based thermoplastic elastomer, an acrylic thermoplastic elastomer, a polycarbonate resin, an acrylic resin, or a polyurethane resin is used, the light guiding means 8 and the attenuation means 9 can be easily and firmly fixed to each other.

The thickness of the base sheet 8 is preferred to be 30 μm to 500 μm. When the thickness is smaller than 30 μm, the base sheet is thin, so the amount of light transmitted to the inside of the base sheet 8 is small and illumination intensity of the display elements 20 is low. When the thickness is greater than 500 μm, it is almost impossible to increase the amount of light entered from an internal light source, and operability of the key sheet 1 is deteriorated because the base sheet 8 has a high rigidity and a necessary force to press the key sheet 1 increases.

As material used for the diffusion layer 10, a resin that can be formed by printing on the base sheet 3 is used. Examples of the resin include a polycarbonate resin, an acrylic resin, a urethane resin, a vinyl chloride resin, a polyester resin, an epoxy resin, and the like. These resins contain a filler having a high refractive index, a filler having a high optical reflectivity, and the like. An example of such a filler includes titanium oxide.

The display element 20 formed of the diffusion layer 10 may be seen when not illuminated, or the display element 20 may not be seen when not illuminated and may be seen only when illuminated.

The key top 4 is formed of a transparent or smoky translucent resin and formed into a rectangular shape in a plan view. The key top 4 is firmly fixed to the operation surface of the base sheet 3 by an adhesive not shown in the drawings.

If the key top 4 is transparent, the display element 20 provided on the back surface side of the key top 4 can be seen when not illuminated, and the display element 20 can be seen with illumination when illuminated. If the key top 4 has a smoke color, the key top 4 can be formed so that the display element 20 provided on the back surface side of the key top 4 cannot be seen when not illuminated and the display element 20 can be seen with illumination when illuminated. Or, the key top 4 can be formed so that the display element 20 is blurred but can be seen when not illuminated and the display element 20 is blurred but can be seen with illumination when illuminated.

As material of resin used for the key top 4, it is preferable to use a highly transparent thermoplastic resin or reactive curable resin among light-transparent resins in order to see the display element 20 clearly. Examples of such a resin include a polycarbonate resin, an acrylic resin, a urethane resin, a polyethylene terephthalate resin, a polyester resin, an epoxy resin, a silicone resin, and the like. When adding a smoke color to the resin, an additive agent is added to these resins to add a smoke color, or an ABS resin having a low transparency is used.

The top cover 5 is formed of a resin or a metal, and as shown in FIG. 3 (A), the top cover 5 is formed into a grid shape having rectangular through holes 5a in a plan view. The above-described key top 4 is displayed in the through hole 5a. The top cover 5 is provided so that the top cover 5 encloses each key top 4 and the outer circumference of the group of the key tops 4 on the operation surface of the base sheet 3.

Examples of the material of the top cover 5 include, as a thermoplastic resin, a polyethylene resin, a polypropylene resin, polystyrene resin, a polycarbonate resin, a polyethylene terephthalate resin, a polybutylene terephthalate resin, an acrylic resin, a polyamide resin, a polyurethane resin, an acrylonitrile-butadiene-styrene copolymer resin, and the like. On the other hand, examples of the material of the top cover 5 include metal materials such as aluminum, titanium, stainless steel, and magnesium alloy.

The pusher sheet 6 includes a resin film 6a and pushers 6b.

The resin film 6a is formed to have substantially the same shape as that of the base sheet 3 and the resin film 6a is firmly fixed to the base sheet 3 by an adhesive layer 11 provided along the outer circumference of the base sheet 3.

Examples of the material of the resin used for the resin film 6a include a polyethylene resin, a polypropylene resin, polystyrene resin, a polycarbonate resin, a polyethylene terephthalate resin, a polybutylene terephthalate resin, an acrylic resin, a polyamide resin, a polyurethane resin, an acrylonitrile-butadiene-styrene copolymer resin, and the like. Among them, a resin film formed of a flexible polyurethane resin having high transparency is preferable.

The pusher 6b is formed of a resin, and the pusher 6b is a member for pressing a contact switch on a circuit board provided on the back surface side of the key sheet 1. The pushers 6b are provided on a surface (back surface) of the resin film 6a facing the circuit board corresponding to each key top 4.

As material used for the pusher 6b, it is preferable to use a thermoplastic resin, a thermo-setting resin, an active energy beam curable resin, and the like due to required performance such as mechanical strength, durability, light weight, and the like. Examples of such resins include a polycarbonate resin, a polyethylene terephthalate resin, an acrylic resin, a polypropylene resin, a polystyrene resin, a polyacrylate copolymer resin, a polyolefin resin, an acrylonitrile butadiene styrene resin, a polyester resin, an epoxy resin, a polyurethane resin, a polyamide resin, a silicone resin, a urethane based thermoplastic elastomer, an olefinic thermoplastic elastomer, an acrylic thermoplastic elastomer, a polyester based thermoplastic elastomer, a polyamide based thermoplastic elastomer, and the like. Among them, an ultraviolet-curable urethane resin including mainly urethane acrylate is preferable because the urethane resin has high mechanical strength and durability.

Here, a manufacturing method of the key sheet 1 will be described.

First, the base sheet 3 having a rubber-like elastic body is formed. The light guiding means 8 including the through hole 8a is formed, and then the attenuation means 9 is formed with a light blocking paint on the wall surface of the through hole 8a. Then, the diffusion layers 10 are formed by printing on the back surface of the base sheet 3. Next, the key tops 4 and the top cover 5 that are formed separately are firmly fixed to the operation surface of the base sheet 3. Finally, the pusher sheet 6 in which the pushers 6b are formed on the resin film 6a is firmly fixed to the back surface of the base sheet 3 by the adhesive layer 11 to obtain the key sheet 1.

Although, in this embodiment, a portion formed on the wall surface of the through hole 8a where the light blocking paint is coated is used as the attenuation means 9, even when the light blocking paint is not coated, the through hole 8a itself can be used as an attenuation means provided in the base sheet 3.

Regarding such an attenuation means, for example, a slit can be formed in a base sheet by using a laser, or, as a method other than the method using a laser, a slit can be formed by cutting the base sheet by using a blade of a Victoria type die or the like. A base sheet including a slit may be formed by injection molding or compression molding. If the end surface of the slit of such a base sheet is formed into a mirror surface, light is reflected on the end surface without being diffused, so the light can illuminate a location far from the light source.

Next, the push button switch 2 including the key sheet 1 will be described.

As shown in FIGS. 5 and 6, the key sheet 1 is mounted inside a housing 7 so that the pushers 6b are in contact with metal domes 13 used as contact switches on the circuit board 12. The outer edges of the key sheet 1 faces LEDs 14 used as internal light sources arranged on the circuit board 12. In this embodiment, there are six LEDs 14 including LED 14a to LED 16f, and the LEDs 14 are arranged on the upper outer edge and the lower outer edge of the key sheet 1 so that the dividing portions 9a which divide the projection surface R of one key top 4 into a left half and a right half and the partition portions 9b which divide the entire projection surfaces R of the key tops 4 into vertical columns in the attenuation means 9 and a light guiding direction of light of the backlight are substantially in parallel with each other.

When the LEDs 14 emit light, as shown by the arrows, the light enters from the outer edges of the light guiding means 8 in the base sheet 3. Then the light is transmitted inside the light guiding means 8 in a surface direction of the base sheet 3 and the path of the light transmitted in the surface direction is changed to the direction toward the key top 4 by the diffusion layer 10. In the key top 4, it is possible to see the diffusion layer 10 that illuminates in the shape of the display element 20. For example, when all the LEDs 14a to 14f are turned on, as shown in FIG. 1, all the display elements 20 in the key tops 4 are illuminated by the backlight and can be seen. When the LEDs 14a to 14c are turned on, as shown in FIG. 2 (A), the display elements 20 on the right side of the key tops 4 are illuminated by the backlight, and the display elements 20 on the left side of the key tops 4 are not illuminated because the backlight is blocked by the dividing portions 9a and the partition portions 9b of the attenuation means 9. When the LEDs 14d to 14f are turned on, as shown in FIG. 2 (B), the display elements 20 on the left side of the key tops 4 are illuminated by the backlight, and the display elements 20 on the right side of the key tops 4 are not illuminated because the backlight is blocked by the dividing portions 9a and the partition portions 9b of the attenuation means 9.

According to the key sheet 1 and the push button switch 2, areas divided by the dividing portions 9a of the attenuation means 9 on the projection surface R of the key top 4 can be respectively illuminated by backlights from different LEDs 14, so the illumination of each divided area can be individually controlled. Therefore, it is possible to realize the key sheet 1 and the push button switch 2 in which the display elements 20 juxtaposed in one key top 4 are divided for each use function and illuminated.

The dividing portions 9a and the partition portions 9b of the attenuation means 9, which are attenuation means, are formed substantially in parallel with the light of the backlight, so the path of the light of the backlight transmitted in the light guiding means 8 can be difficult to be blocked by the dividing portions 9a and the partition portions 9b of the attenuation means 9, and thus, the light guiding efficiency can be enhanced.

Since the light guiding means is the light guiding means 8 formed of a rubber-like elastic body, the base sheet 3 can be elastically deformed, so it is possible to achieve an operational feeling of pressing corresponding to the elastic deformation when a pressing operation is performed.

Since the attenuation means is the attenuation means 9 formed of a rubber-like elastic body, the attenuation means can be elastically deformed, so it is possible to enhance pressing operability when a pressing operation is performed.

Since the attenuation means 9 is formed to be hollow, the weight of the base sheet can be lightened. When a pressing operation is performed, the partition portions 9b can insulate the stress to the adjacent key top 4, so it is possible to make it difficult for the adjacent key tops 4 to operate together.

Since the diffusion layer 10 is formed in the shape of the display element 20 on the back surface of the base sheet 3, the display element 20 sunk deeply in the key top 4 can be seen by the illumination of the backlight.

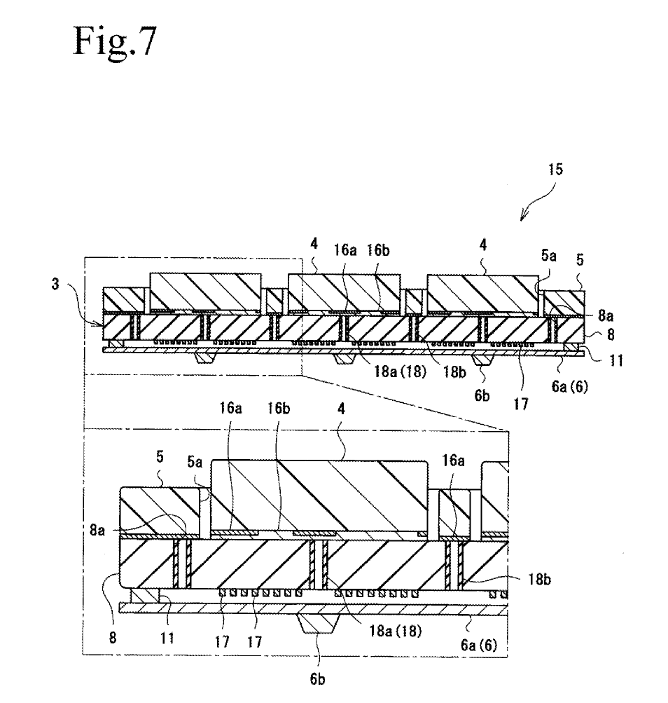

### First Modification Example of the First Embodiment [FIG. 7]

Although, in the key sheet 1 of the first embodiment, an example in which the display elements 20 are provided on the back surface of the base sheet 3 is described, in the key sheet 15 of the first modification example, it is possible to form a printed display layer 16 including a light blocking layer 16a and a light passing layer 16b on the back surface of the key top 4 and form diffusion layers 17 that are dotted and spread on the back surface of the base sheet 3. Further, it is possible to change the attenuation means 9 to a light reflecting layer 18 and change the dividing layer 9a and the separation layer 9b respectively to a dividing layer 18a and a separation layer 18b.

Also, in this way, it is possible to divide and illuminate the display elements 20 juxtaposed in one key top 4 for each use function, and further, it is possible to make it easier to see the display elements 20 even when not illuminated. Further, since the attenuation means is the light reflecting layer, it is possible to make it difficult to transmit the light transmitted in the light guiding means 8 to a light guiding means 9 across the light reflecting layer 18, so that it is possible to brightly illuminate the key top 4 for each area divided by the light reflecting layer 18.

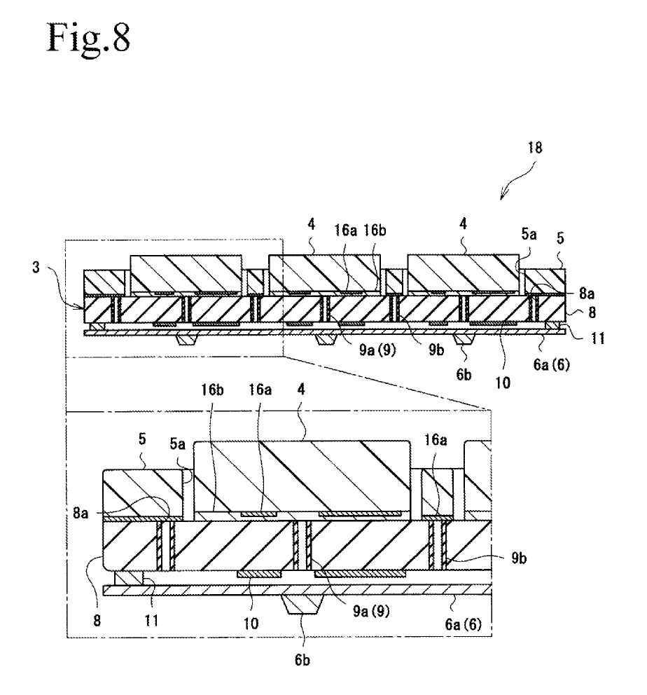

### Second Modification Example of the First Embodiment [FIG. 8]

Although, in the key sheet 1 of the first embodiment, an example in which the printed display layer is not provided on the back surfaces of the key top 4 and the top cover 5 is described, in the key sheet 18 of the second modification example, it is possible to form the printed display layer 16 including the light blocking layer 16a representing the display element 20 having a shape similar to and slightly smaller than the diffusion layer 10 and the transparent light passing layer 16b covering the entire back surface of the key top 4 on the back surface of the key top 4.

Also, in this way, it is possible to divide and illuminate the display elements 20 juxtaposed in one key top 4 for each use function and make it easier to see the display elements 20 even when not illuminated. Further, when illuminated, it is possible to see that the contour of the display element 20 is illuminated.

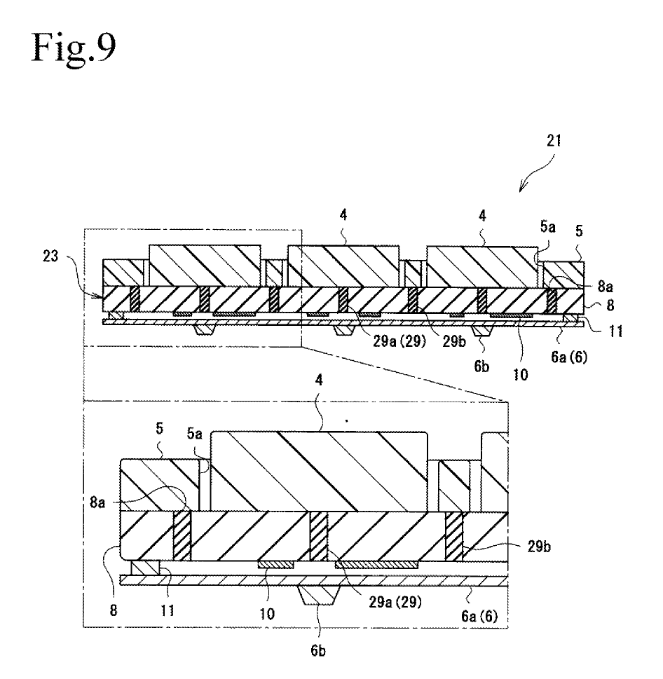

### Second Embodiment [FIG. 9]

FIG. 9 shows a key sheet 21 of the second embodiment. FIG. 9 shows a cross-sectional view of the key sheet 21. The difference of the key sheet 21 of the second embodiment from the key sheet 1 of the first embodiment is a configuration of an attenuation means 29 included in a base sheet 23. The other configurations, and operations and effects thereof are the same as those of the key sheet 1.

In the same manner as the attenuation means 9, the attenuation means 29 is formed in the through hole 8a of the light guiding means 8 and includes dividing portions 29a which divide the projection surface R of one key top 4 into a left half and a right half and partition portions 29b which divide the entire projection surfaces R of the key tops 4 into vertical columns. The difference from the attenuation means 9 is that the attenuation means 29 is formed to be solid.

A manufacturing method of the key sheet 21 will be described. First, the base sheet 23 having a rubber-like elastic body is formed. The light guiding means 8 including the through hole 8a is formed, and then the attenuation means 29 having a rubber-like elastic body is formed inside the through hole 8a. Then, the diffusion layers 10 are formed by printing on the back surface of the base sheet 23. Next, the key tops 4 and the top cover 5 that are formed separately are firmly fixed to the operation surface of the base sheet 23. Finally, the pusher sheet 6 is firmly fixed to the back surface of the base sheet 23 by the adhesive layer 11 to obtain the key sheet 21. The attenuation means 29 may be an opaque resin as well as a rubber-like elastic body. For example, the attenuation means 29 may be a white resin.

In the same way as the key sheet 1, the key sheet 21 can be included in the push button switch 2. The key sheet 21 is mounted inside the housing 7 so that the pushers 6b are in contact with metal domes 13 used as contact switches on the circuit board 12. The outer edges of the key sheet 21 faces LEDs 14 used as internal light sources arranged on the circuit board 12. There are six LEDs 14 including LED 14a to LED 16f, and the LEDs 14 are arranged on the upper outer edge and the lower outer edge of the key sheet 21 so that the dividing portions 29a and the partition portions 29b in the attenuation means 29 and a light guiding direction of the light of the backlight are substantially in parallel with each other (see FIGS. 5 and 6).

When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight, and the display elements 20 on the left side of the key tops 4 are not illuminated because the backlight is blocked by the dividing portions 29a and the partition portions 29b. When the LEDs 14d to 14f are turned on, the display elements 20 on the left side of the key tops 4 are illuminated by the backlight, and the display elements 20 on the right side of the key tops 4 are not illuminated because the backlight is blocked by the dividing portions 29a and the partition portions 29b (see FIGS. 1 and 2).

According to the key sheet 21, the attenuation means 29 is formed to be solid, so the rigidity of the base sheet 23 can be increased. Thereby the key sheet 23 is easily manufactured and easily mounted in a mobile phone.

Further, if the elastic moduli of the light guiding means 8 and the attenuation means 29, both of which are formed of a rubber-like elastic body, are set to the same value, the base sheet 23 can be elastically deformed uniformly, so it is possible to improve the operational feeling of pressing as well as realize a correct pressing operation.

If the entire pusher sheet 6 is firmly fixed to the back surface side of the base sheet 23, the rigidity of the base sheet 23 can be further reinforced.

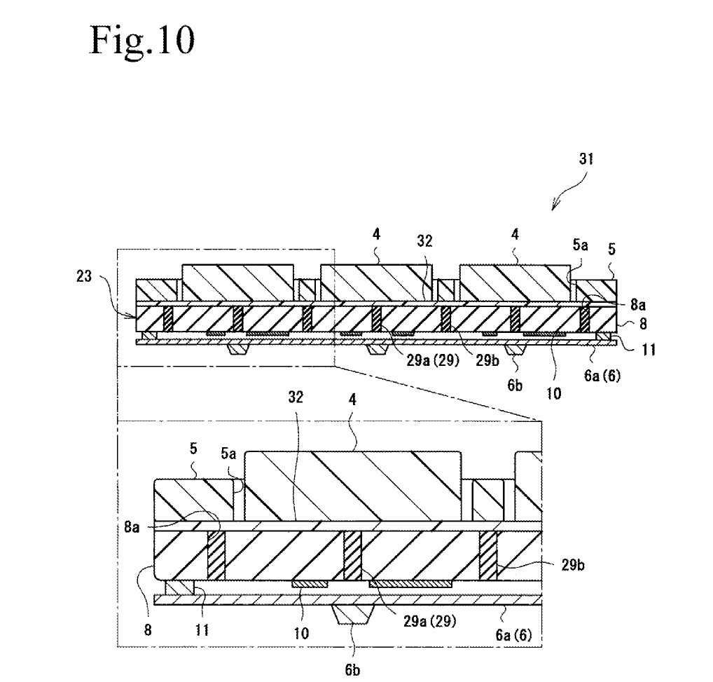

### Third Embodiment [FIG. 10]

FIG. 10 shows a key sheet 31 of the third embodiment. FIG. 10 shows a cross-sectional view of the key sheet 31. The difference of the key sheet 31 of the third embodiment from the key sheet 21 of the second embodiment is a configuration in which the base sheet 23 includes a resin film 32. The other configurations, and operations and effects thereof are the same as those of the key sheet 21.

The resin film 32 is formed of a transparent resin and firmly fixed to the operation surface of the base sheet 23 so that the resin film 32 covers the entire operation surface of the base sheet 23. The resin film 32 is a layer provided so that the key tops 4, the top cover 5, and the base sheet 8 are firmly fixed and integrated together. These do not necessarily have to be firmly fixed. For example, it is possible to integrate the key tops 4 and the top cover 5 with the resin film 32, attach the base sheet 8 to the integrated one without firmly fixing the base sheet 8, and mount them in a device.

The material of the resin used for the resin film 32 is preferred to have flexibility and high transparency. Examples of such a resin include a polyethylene resin, a polypropylene resin, a polycarbonate resin, a polyethylene terephthalate resin, a polybutylene terephthalate resin, an acrylic resin, a polyamide resin, a polyurethane resin, a urethane based thermoplastic elastomer, an olefinic thermoplastic elastomer, an acrylic thermoplastic elastomer, a polyester based thermoplastic elastomer, a polyamide based thermoplastic elastomer, and the like.

A manufacturing method of the key sheet 31 will be described. First, the base sheet 23 having a rubber-like elastic body is formed. The light guiding means 8 including the through hole 8a is formed on the resin film 32, and then the attenuation means 29 having a rubber-like elastic body is formed by injecting a liquid rubber into the inside of the through hole 8a and hardening the liquid rubber. Then, the diffusion layers 10 are formed by printing on the back surface of the base sheet 23. Next, the key tops 4 and the top cover 5 that are formed separately are firmly fixed to the operation surface side of the resin film 32. Finally, the pusher sheet 6 is firmly fixed to the back surface of the base sheet 23 by the adhesive layer 11 to obtain the key sheet 31.

In the same way as the key sheet 21, the key sheet 31 can be included in the push button switch 2. When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight. When the LEDs 14d to 14f are turned on, the display elements 20 on the left side of the key tops 4 are illuminated by the backlight.

According to the key sheet 31, the transparent resin film 32 is provided on the operation surface side of the base sheet 23, so the key tops 4 and the top cover 5 can be strongly fixed without being influenced by the material of the base sheet 23. As a modification example, the display elements 20 and the diffusion layers can be formed by printing on the resin film 32, so the display elements 20 and the diffusion layers can be easily provided without being influenced by the material of the base sheet 23.

In the manufacturing of the base sheet 23, the attenuation means 9 is provided after the light guiding means 8 is provided on the resin film 32, so it is possible to prevent the attenuation means 9 from covering the operation surface side of the light guiding means 8, and thus the base sheet 23 can be easily obtained.

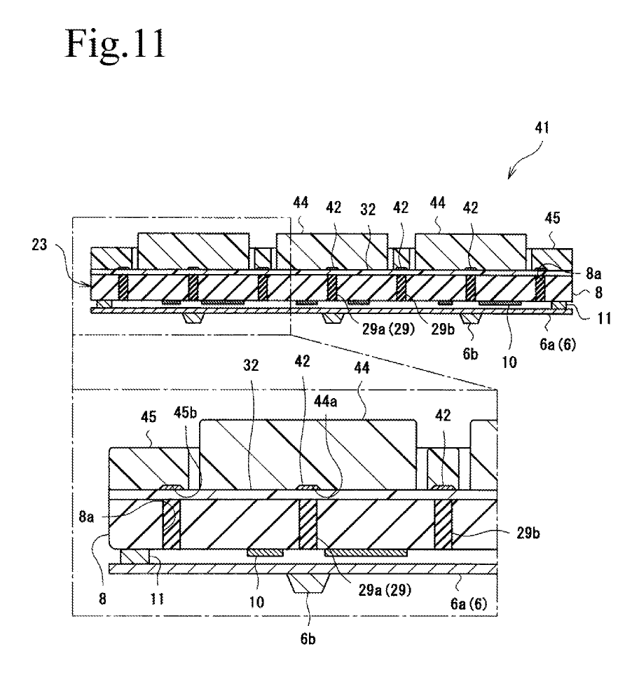

### Fourth Embodiment [FIG. 11]

FIG. 11 shows a key sheet 41 of the fourth embodiment. FIG. 11 shows a cross-sectional view of the key sheet 41. The difference of the key sheet 41 of the fourth embodiment from the key sheet 31 of the third embodiment is a point that the key sheet 41 includes a blindfold portion 42 and configurations of the key top 44 and the top cover 45. The other configurations, and operations and effects thereof are the same as those of the key sheet 31.

The blindfold portion 42 is firmly fixed to the operation surface of the resin film 32 and has a cross-sectional trapezoidal shape whose width is slightly larger than the width of the attenuation means 29. The blindfold portion 42 is formed to cover the operation surface side of the attenuation means 29 and meander in a square wave shape in a plan view.

As material used for the blindfold portion 42, a material that can be firmly fixed to the resin film 32, such as a paint made from a rubber-like elastic body containing pigment and a resin, or a curable resin containing pigment is used. For example, if the same type thermoplastic resin as that of the light guiding means 8, such as a polycarbonate resin, an acrylic resin, a urethane resin, a urethane based thermoplastic elastomer, or an acrylic thermoplastic elastomer is used, the light guiding means 8 and the blindfold portion 42 can be easily and firmly fixed to each other by thermocompression bonding.

The key top 44 and the top cover 45 respectively have substantially the same shapes as those of the key top 4 and the top cover 5. The difference between the formers and the latters is that reception concave portions 44a and 45b, which receive the blindfold portion 42, are formed on the back surfaces of the key tops 44 and the top cover 45.

A manufacturing method of the key sheet 41 will be described. First, the base sheet 23 having a rubber-like elastic body is formed. The light guiding means 8 including the through hole 8a is formed on the resin film 32, and then the attenuation means 29 having a rubber-like elastic body is formed by injecting a liquid rubber into the inside of the through hole 8a and hardening the liquid rubber. Then, the diffusion layers 10 are formed by printing on the back surface of the base sheet 23. Next, the blindfold portion 42 is formed on the operation surface side of the resin film 32, and then the key tops 44 and the top cover 45 that are formed separately are firmly fixed to the operation surface side of the resin film 32. Finally, the pusher sheet 6 is firmly fixed to the back surface of the base sheet 23 by the adhesive layer 11 to obtain the key sheet 41. The blindfold portion 42 may be provided by printing a portion to be the blindfold portion 42 on a mold release film and transferring the portion to the resin film 32.

In the same way as the key sheet 31, the key sheet 41 can be included in the push button switch 2. When all the LEDs 14a to 14f are turned on, all the display elements 20 in the key tops 44 are illuminated by the backlight and can be seen. When the LEDs 14a to 14c are turned on, the display elements 20 on the right side of the key tops 44 are illuminated by the backlight. When the LEDs 14d to 14f are turned on, the display elements 20 on the left side of the key tops 44 are illuminated by the backlight.

According to the key sheet 41, since the blindfold portion 42 that covers the attenuation means 29 is provided on the operation surface side of the base sheet 23, even when the interface between the attenuation means 29 and the light guiding means 8 shines brightly, it is possible to make it difficult to see the interface through the key top 44, and thereby the appearance of the key sheet 41 when illuminated can be improved.

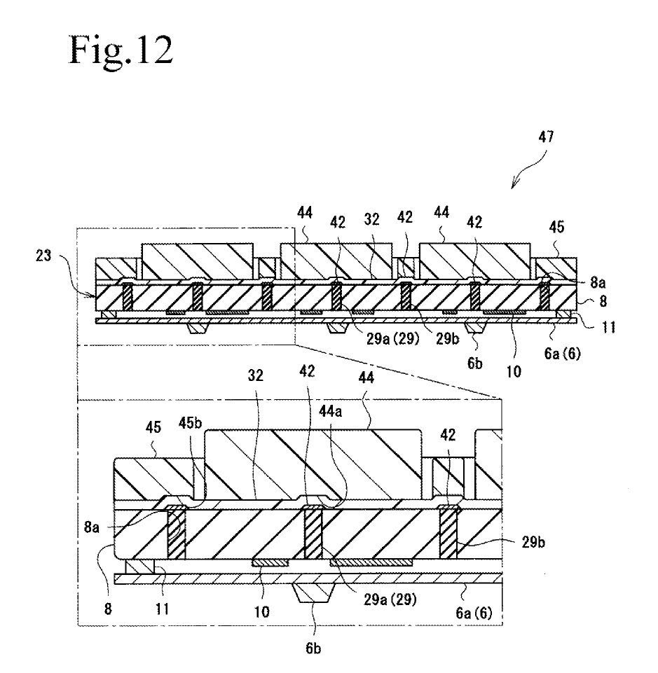

### Modification Example of the Fourth Embodiment [FIG. 12]

Although, in the key sheet 41 of the fourth embodiment, an example in which the blindfold portion 42 is provided on the operation surface side of the resin film 32 is described, in the key sheet 47 of the modification example, the blindfold portion 42 can be provided on the back surface side of the resin film 32 by screen printing or the like.

Also, in this way, even when the interface between the attenuation means 29 and the light guiding means 8 shines brightly, it is possible to make it difficult to see the interface through the key top 44 by the blindfold portion 42, and thereby the appearance of the key sheet 47 when illuminated can be improved.

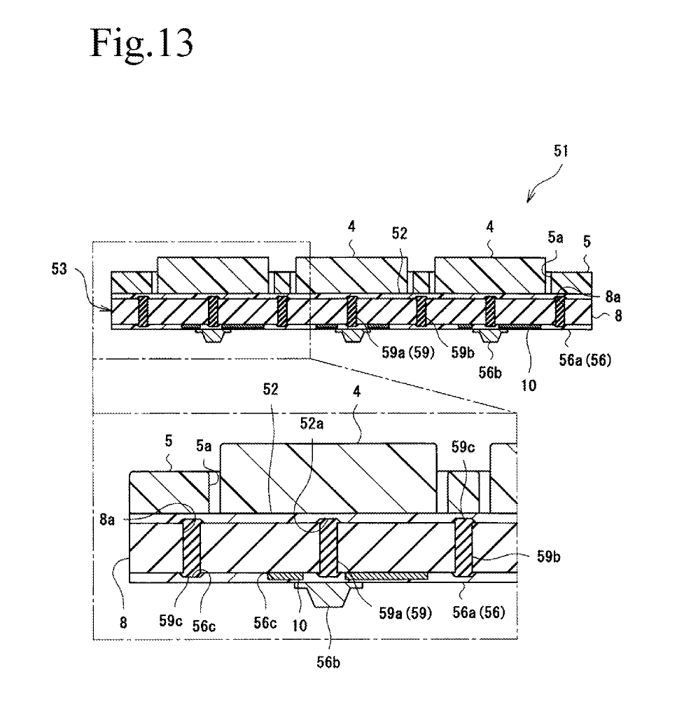

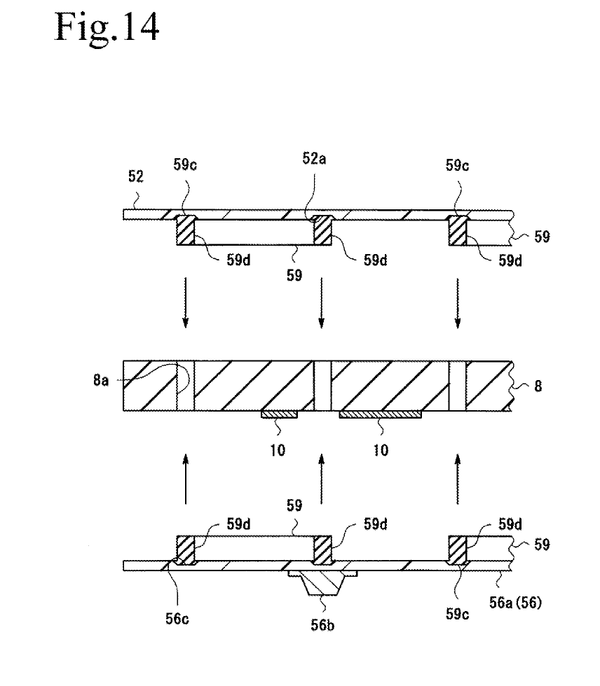

### Fifth Embodiment [FIGS. 13 and 14]

FIGS. 13 and 14 show a key sheet 51 of the fifth embodiment. FIG. 13 shows a cross-sectional view of the key sheet 51. FIG. 14 shows an illustration of a manufacturing process of the key sheet 51. The difference of the key sheet 51 of the fifth embodiment from the key sheet 31 of the third embodiment is configurations of a resin film 52, a base sheet 53, and a pusher sheet 56. The other configurations, and operations and effects thereof are the same as those of the key sheet 31.

The base sheet 53 is formed of the light guiding means 8 and an attenuation means 59.

In the same manner as the attenuation means 29, the attenuation means 59 includes the dividing portions 29a which divide the projection surface R of one key top 4 into a left half and a right half and the partition portions 59b which divide the entire projection surfaces R of the key tops 4 into vertical columns. The attenuation means 59 is formed to be solid. The difference from the attenuation means 29 is that a protrusion portion 59c protruding to the outside of the light guiding means 8 is formed at both ends of the attenuation means 59 on the operation surface side and the back surface side and the protrusion portion 59c is formed to be a cross-sectional trapezoidal shape whose width is slightly larger than the width of the through hole 8a. The protrusion portion 59c forms “blindfold portion”.

In the same manner as the resin film 32, the resin film 52 is firmly fixed to the operation surface side of the base sheet 53 so that the resin film 32 covers the entire operation surface side of the base sheet 53. The difference from the resin film 32 is that reception concave portions 52a that receive the protrusion portions 59c are formed on the operation surface side of the base sheet 53.

In the same manner as the pusher sheet 6, the pusher sheet 56 includes a resin film 56a and pushers 56b. The difference from the pusher sheet 6 is that reception concave portions 56c that receive the protrusion portions 59c and the diffusion layers 10 are formed on the back surface side of the base sheet 53.

A manufacturing method of the key sheet 51 will be described. First, the light guiding means 8 including the through hole 8a is formed, and then the diffusion layers 10 are formed by printing on the back surface of the light guiding means 8. Then, a light blocking elastic body 59d formed of a thermoplastic elastomer used for the attenuation means 59 is formed on the back surface side of the resin film 52. The light blocking elastic body 59d meanders in a square wave shape in a plan view. The light blocking elastic body 59d is formed to have a length of approximately a half of the length that fills the through hole 8a of the light guiding means 8 in a cross-sectional view. A light blocking elastic body 59d formed on the pusher sheet 56 integrally form the attenuation means 59.

The light blocking elastic body 59d is formed by printing on the operation surface side of the pusher sheet 56 where the pushers 56b are formed by using an ultraviolet curable resin or the like as the resin film 56a. Thereafter, as shown in FIG. 14, the light guiding means 8 is sandwiched by the resin film 52 and the pusher sheet 56 and bonded by thermal compression. Finally, the key tops 4 and the top cover 5 that are formed separately are firmly fixed to the operation surface side of the resin film 52 to obtain the key sheet 51.

In the same way as the key sheet 31, the key sheet 51 can be included in the push button switch 2. When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight. When the LEDs 14d to 14f are turned on, the display elements 20 on the left side of the key tops 4 are illuminated by the backlight.

According to the key sheet 51, it is possible to make it difficult to see the interface between the attenuation means 59 and the light guiding means 8 through the key top 4 by the protrusion portion 59c acting as “blindfold portion”, and thereby the appearance of the key sheet 51 when illuminated can be improved.

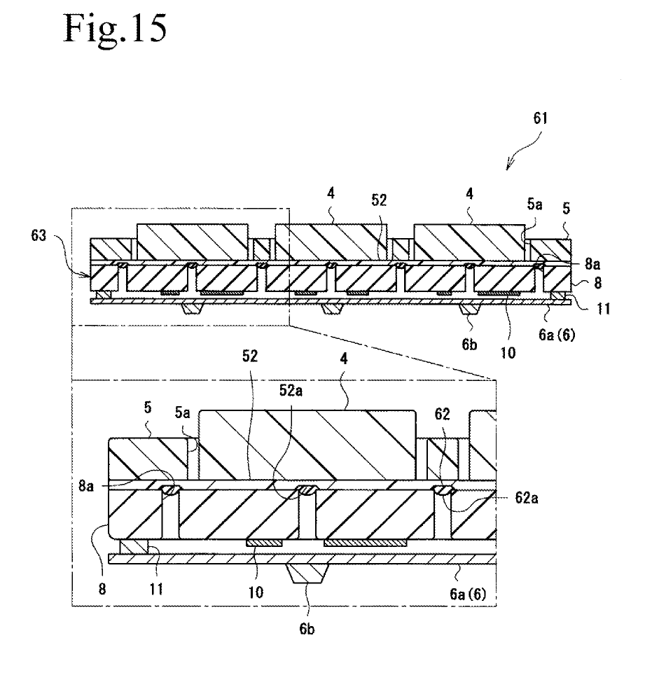

### Sixth Embodiment [FIG. 15]

FIG. 15 shows a key sheet 61 of the sixth embodiment. FIG. 15 shows a cross-sectional view of the key sheet 61. The difference of the key sheet 61 of the sixth embodiment from the key sheet 31 of the third embodiment is a point that the key sheet 61 includes the resin film 52 and a configuration of a base sheet 63. The other configurations, and operations and effects thereof are the same as those of the key sheet 31.

In the resin film 52, a blindfold portion 62 is formed in the reception concave portion 52a. The blindfold portion 62 fills the reception concave portion 52a. The tip portion 62a of the blindfold portion 62 protruding from the back surface of the resin film 52 goes into the through hole 8a of the light guiding means 8 and firmly fixed to the wall of the through hole 8a.

The base sheet 63 is formed of the light guiding means 8. The space inside the through hole 8a forms “attenuation means”.

A manufacturing method of the key sheet 61 will be described. First, the through hole 8a to be the light guiding means 8 is formed, and then the diffusion layers 10 are formed by printing on the back surface of the light guiding means 8. Then, the blindfold portion 62 formed of a thermoplastic elastomer is formed on the back surface side of the resin film 52 by thermal compression bonding. Then, the resin film 52 and the light guiding means 8 are bonded by thermal compression and integrated together. Thereafter, the key tops 4 and the top cover 5 that are formed separately are firmly fixed to the operation surface side of the resin film 52. Finally, the pusher sheet 6 is firmly fixed to the back surface of the base sheet 63 by the adhesive layer 11 to obtain the key sheet 61.

In the same way as the key sheet 31, the key sheet 61 can be included in the push button switch 2. When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight. When the LEDs 14d to 14f are turned on, the display elements 20 on the left side of the key tops 4 are illuminated by the backlight.

According to the key sheet 61, since the space in the through hole 8a is used as the attenuation means, it is possible to make it difficult to transmit the light transmitted in the light guiding means 8 to the light guiding means 8 across the space, so that it is possible to illuminate the key top 4 for each area divided by the space.

The blindfold portion 62 can make it difficult to see the edge surface of the light guiding means 8 in contact with the space through the key top 4, and thereby the appearance of the key sheet 61 when illuminated can be improved.

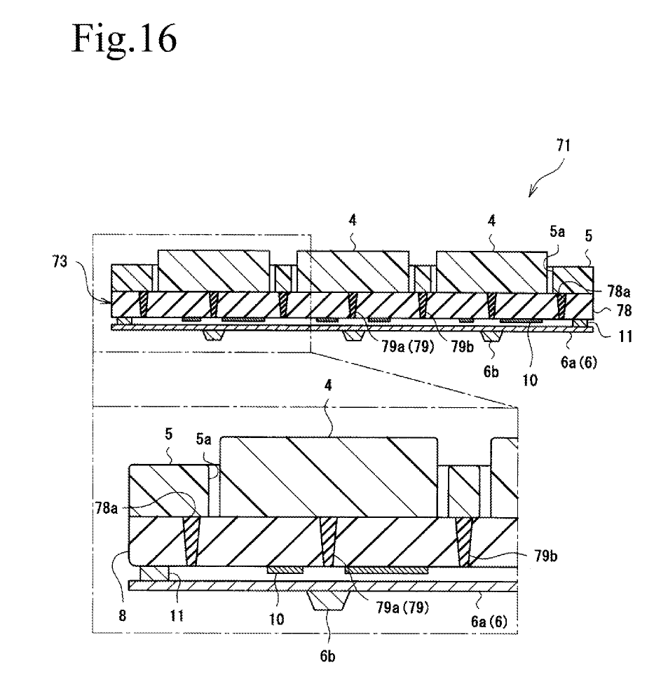

### Seventh Embodiment [FIG. 16]

FIG. 16 shows a key sheet 71 of the seventh embodiment. FIG. 15 shows a cross-sectional view of the key sheet 71. The difference of the key sheet 71 of the seventh embodiment from the key sheet 21 of the second embodiment is a configuration of a base sheet 73. The other configurations, and operations and effects thereof are the same as those of the key sheet 21.

In the same manner as the base sheet 23, the base sheet 73 is formed of a light guiding means 78 formed of a rubber-like elastic body and an attenuation means 79 formed of a rubber-like elastic body.

In the same manner as in the light guiding means 8, in a light guiding means 78, a through hole 78a is formed which meanders in a square wave shape in a plan view. The difference from the light guiding means 8 is that the width of the opening of the through hole 78a on the operation surface side is formed larger than the width of the opening on the back surface side.

In the same manner as the attenuation means 29, the attenuation means 79 is formed in the through hole 78a of the light guiding means 78 and includes dividing portions 79a which divide the projection surface R of one key top 4 into a left half and a right half and partition portions 79b which divide the entire projection surfaces R of the key tops 4 into vertical columns. The difference from the attenuation means 29 is that the cross-sectional shape is formed to be a trapezoidal shape that fills the through hole 78a. In other words, the interface of the attenuation means 79 with the light guiding means 78 faces the back surface side of the base sheet 73.

A manufacturing method of the key sheet 71 will be described. First, the base sheet 73 having a rubber-like elastic body is formed. The light guiding means 78 including the through hole 78a is formed, and then the attenuation means 79 having a rubber-like elastic body is formed inside the through hole 78a. Then, the diffusion layers 10 are formed by printing on the back surface of the base sheet 73. Next, the key tops 4 and the top cover 5 that are formed separately are firmly fixed to the operation surface of the base sheet 73. Finally, the pusher sheet 6 is firmly fixed to the back surface of the base sheet 73 by the adhesive layer 11 to obtain the key sheet 71.

In the same way as the key sheet 21, the key sheet 71 can be included in the push button switch 2. When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight. When the LEDs 14d to 14f are turned on, the display elements 20 on the left side of the key tops 4 are illuminated by the backlight.

According to the key sheet 71, since the interface of the attenuation means 79 formed in the thickness direction of the base sheet 73 with the light guiding means 78 faces the back surface side opposite to the operation surface side of the base sheet 73, it is possible to make it difficult to see the interface between the attenuation means 79 and the light guiding means 78 through the key top 4, and thereby the appearance of the key sheet 71 when illuminated can be improved.

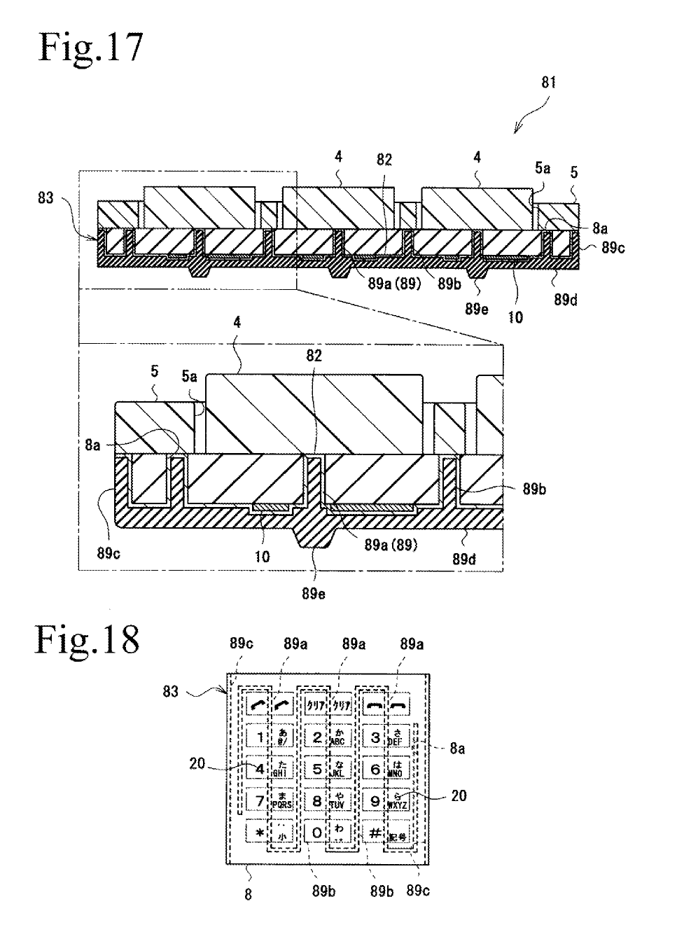

### Eighth Embodiment [FIGS. 17 and 18]

FIG. 17 shows a key sheet 81 of the eighth embodiment. FIG. 17 shows a cross-sectional view of the key sheet 81. FIG. 18 shows a plan view of a base sheet 83 included in the key sheet 81. The difference of the key sheet 81 of the eighth embodiment from the key sheet 21 of the second embodiment is a configuration of the base sheet 83. The other configurations, and operations and effects thereof are the same as those of the key sheet 21.

The base sheet 83 includes the light guiding means 8, an attenuation means 89 formed of a rubber-like elastic body, and a resin film 82 sandwiched between the light guiding means 8 and the attenuation means 89.

In the same manner as the attenuation means 29, the attenuation means 89 is formed in the through hole 8a of the light guiding means 8 and includes dividing portions 89a which divide the projection surface R of one key top 4 into a left half and a right half and partition portions 89b which divide the entire projection surfaces R of the key tops 4 into vertical columns. The difference from the attenuation means 29 is that side surface coating portions 89c covering a part of the outer edges of the light guiding means 8 and a back surface coating portion 89d covering the back surface of the light guiding means 8 are provided. Further, pusher portions 89d are provided on the back surface of the back surface coating portion 89d corresponding to the key tops 4. As shown in FIG. 18, the side surface coating portions 89c of this embodiment cover the left and right outer edges of the light guiding means 8.

The resin film 82 is formed of a transparent resin and firmly fixed between the light guiding means 8 including the diffusion layers 10 and the attenuation means 89.

A manufacturing method of the key sheet 81 will be described. First, the base sheet 83 having a rubber-like elastic body is formed. The light guiding means 8 including the through hole 8a is formed, and then the diffusion layers 10 are formed by printing on the back surface of the light guiding means 8. Then the resin film 82 is firmly fixed to the back surface and side surfaces of the light guiding means 8 and the inside of the through hole 8a by deforming the resin film 82 by a drawing operation. Next, the attenuation means 89 is formed by inserting the light guiding means 8 integrated together with the resin film 82 into a casting mold of the attenuation means 89. Finally, the key tops 4 and the top cover 5 that are formed separately are firmly fixed to the operation surface of the base sheet 83 to obtain the key sheet 81.

In the same way as the key sheet 21, the key sheet 81 can be included in the push button switch 2. When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight. When the LEDs 14d to 14f are turned on, the display elements 20 on the left side of the key tops 4 are illuminated by the backlight.

According to the key sheet 81, since the side surface coating portions 89c of the attenuation means 89 cover a part of the outer edges of the base sheet 83, it is possible to make it difficult for the backlight transmitted in the light guiding means 8 of the base sheet 83 to leak from the outer edges of the base sheet 83, so the light guiding efficiency can be enhanced.

Since the back surface coating portion 89d of the attenuation means 89 covers the back surface of the base sheet 83, it is possible to make it difficult for the backlight transmitted in the light guiding means 8 of the base sheet 83 to leak from the back surface of the base sheet 83, so the light guiding efficiency can be enhanced. The back surface coating portion 89d may be a background of the display elements 20.

Since the resin film 82 is provided between the light guiding means 8 and the attenuation means 89, the rigidity of the base sheet 83 can be increased, and the key sheet 81 is easily manufactured and easily mounted in an electronic device.

In the manufacturing of the base sheet 83, the light guiding means 8 and the attenuation means 89 are formed with the resin film 82 in between, so it is possible to prevent the attenuation means 89 from covering the operation surface side of the light guiding means 8, or prevent the light guiding means 8 from covering the operation surface side of the attenuation means 89, and thus the base sheet 83 can be easily obtained.

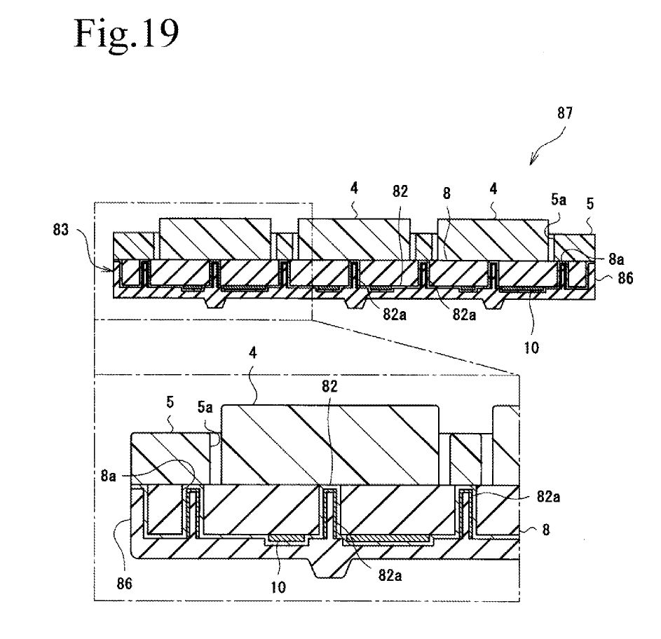

### Modification Example of the Eighth Embodiment [FIG. 19]

Although, in the key sheet 81 of the eighth embodiment, an example is described in which the rubber-like elastic body that fills the through hole 8a of the light guiding means 8 and covers a part of the outer edges and the back surface of the light guiding means 8 is used as the attenuation means 89, in the key sheet 87 of the modification example, it is possible to use a light-transparent coating portion 86 as the rubber-like elastic body that fills the through hole 8a of the light guiding means 8 and covers a part of the outer edges and the back surface of the light guiding means 8 and provide a light blocking printed layer 82a as “attenuation means” on the resin film 82 inside the through hole 8a.

For example, the key sheet 81 can be manufactured as described below.

The diffusion layers 10 are formed on the base sheet 8 formed of a polycarbonate sheet of about 200 μm by screen printing using white ink. An adhesive layer for the resin film 82 formed of a urethane is formed on the entire surface from above the diffusion layers 10 by screen printing. A slit is formed in the base sheet 8 by a laser. A light blocking printed layer 82a to be an attenuation means 82a is formed on the resin film 82 at a position corresponding to the slit. Then, the base sheet 8 and the resin film 82 are bonded together by thermal compression. The base sheet 8 is inserted into a mold for the rubber-like elastic body whose surface facing the resin film 82 becomes the coating portion 86 and the like, and integrated by compression molding. On the other hand, the key tops 4 made of polycarbonate are formed by injection molding. The top cover 5 is manufactured by printing the printed display layer 16 and the like on a PET sheet as needed and cutting out holes in which the key tops 4 are arranged and the outer circumference of the product by a Victoria type die. Finally, the top cover 5 and the key tops 4 are firmly fixed to the base sheet 8 by a two-sided adhesive tape.

The light blocking printed layer 82a may be formed on the resin film 82 before being integrated with the light guiding means 8. Even when doing so, it is possible to divide the projection surface R of one key top 4 into a left half and a right half and divide the entire projection surfaces R of the key tops 4 into vertical columns by using the light blocking printed layer 82a, so the illumination of the display elements 20 can be controlled by the LEDs 14a to 14f. Further, the light-transparent coating portion 86 has a light guiding function, so the illumination intensity can be enhanced.

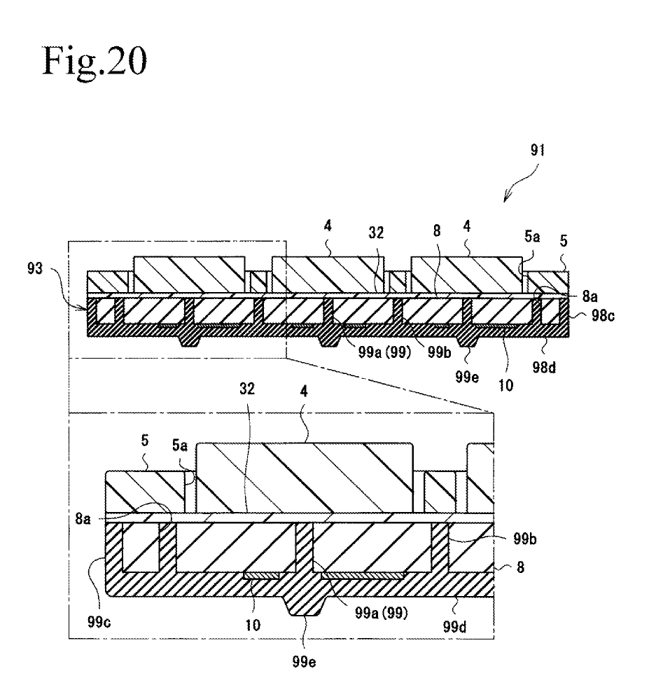

### Ninth Embodiment [FIG. 20]

FIG. 20 shows a key sheet 91 of the ninth embodiment. FIG. 20 shows a cross-sectional view of the key sheet 91. The difference of the key sheet 91 of the ninth embodiment from the key sheet 31 of the third embodiment is a configuration of the base sheet 93. The other configurations, and operations and effects thereof are the same as those of the key sheet 31.

The base sheet 93 includes the light guiding means 8 and an attenuation means 99 formed of a rubber-like elastic body.

In the same manner as the attenuation means 29, the attenuation means 99 is formed in the through hole 8a of the light guiding means 8 and includes dividing portions 99a which divide the projection surface R of one key top 4 into a left half and a right half and partition portions 99b which divide the entire projection surfaces R of the key tops 4 into vertical columns. The difference from the attenuation means 29 is that a side surface coating portion 99c covering a part of the outer edges of the light guiding means 8 and a back surface coating portion 99d covering the back surface of the light guiding means 8 are provided. Further, pusher portions 99e are provided on the back surface of the back surface coating portion 99d corresponding to the key tops 4. The side surface coating portions 99c of this embodiment cover the left and right outer edges of the light guiding means 8 (see FIG. 18).

A manufacturing method of the key sheet 91 will be described. First, the base sheet 93 having a rubber-like elastic body is formed. The light guiding means 8 including the through hole 8a is formed on the resin film 32, and then the attenuation means 99 is formed by inserting the light guiding means 8 integrated together with the resin film 32 into a casting mold of the attenuation means 99. Finally, the key tops 4 and the top cover 5 that are formed separately are firmly fixed to the operation surface side of the resin film 32 to obtain the key sheet 91.

In the same way as the key sheet 31, the key sheet 91 can be included in the push button switch 2. When all the LEDs 14a to 14f are turned on, all the display elements 20 in the key tops 4 are illuminated by the backlight and can be seen. When the LEDs 14a to 14c are turned on, the display elements 20 on the right side of the key tops 4 are illuminated by the backlight. When the LEDs 14d to 14f are turned on, the display elements 20 on the left side of the key tops 4 are illuminated by the backlight.

According to the key sheet 91, since the side surface coating portions 99c of the attenuation means 99 cover a part of the outer edges of the base sheet 93, it is possible to make it difficult for the backlight transmitted in the light guiding means 8 of the base sheet 93 to leak from the outer edges of the base sheet 93, so the light guiding efficiency can be enhanced.

Since the back surface coating portion 99d of the attenuation means 99 covers the back surface of the base sheet 93, it is possible to make it difficult for the backlight transmitted in the light guiding means 8 of the base sheet 93 to leak from the back surface of the base sheet 93, so the light guiding efficiency can be enhanced. The back surface coating portion 99d may be a background of the display elements 20.

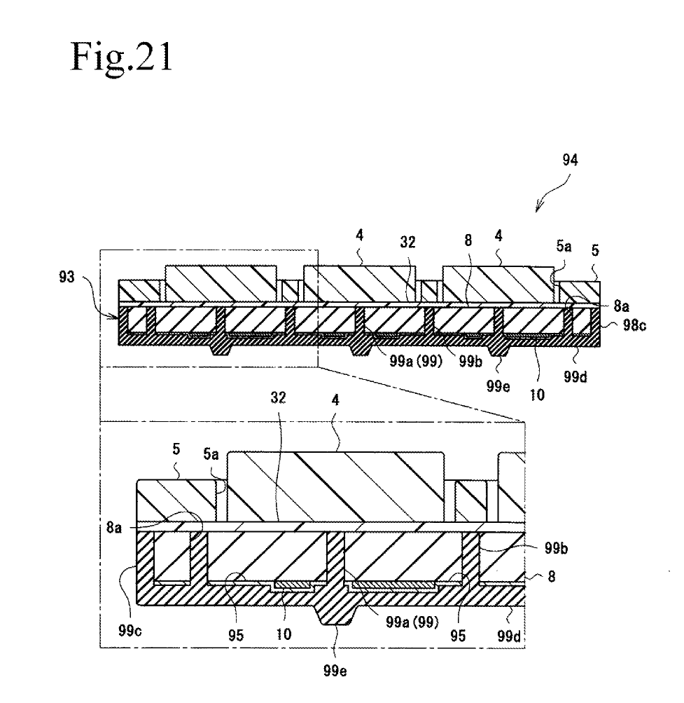

### First Modification Example of the Ninth Embodiment [FIG. 21]

Although, in the key sheet 91 of the ninth embodiment, an example in which the back surface coating portion 99d of the attenuation means 99 is used as the background of the display elements 20 is described, in the key sheet 94 of the first modification example, a light color layer 95 can be provided between the back surfaces of the light guiding means 8 and the diffusion layers 10 and the back surface coating portion 99d of the attenuation means 99.

By doing so, it is possible to make it more difficult for the light color layer 95 than for the back surface coating portion 99d to absorb light, and thus, the light guiding efficiency can be enhanced. Further, the light color layer 95 may be the background of the display elements 20.

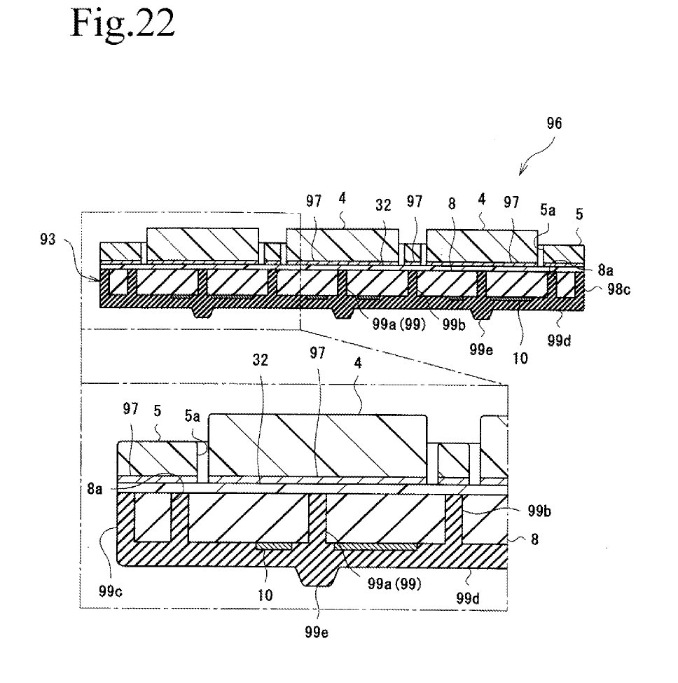

### Second Modification Example of the Ninth Embodiment [FIG. 22]

Although, in the key sheet 91 of the ninth embodiment, an example in which no decoration is added to the back surface of the key top 4 is described, in the key sheet 96 of the second modification example, a half deposition layer 97 can be provided on the back surface of the key top 4.

The half deposition layer 97 can be provided by foil transfer.

Since the half deposition layer 97 passes light while representing a mirror like gloss, it is possible to realize a new design in which the key tops 4 and the top cover 5 represent a metallic tone and the display elements 20 cannot seen when not illuminated but the display elements 20 can seen when illuminated.

Besides the half deposition layer, if a light-transparent black printed layer or color printed layer, or a light diffusion translucent resin layer is used, it is possible to make it difficult to see the diffusion layer when not illuminated.

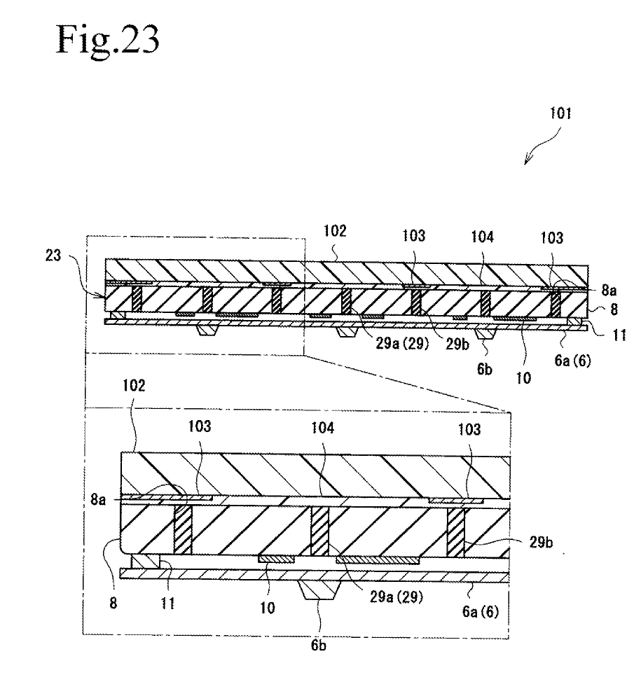

### Modification Example 1 Common to Each Embodiment [FIG. 23]

Here, a modification example common to each embodiment will be described using the key sheet 31 of the third embodiment as an example.

Although, in the key sheet 31 of the third embodiment, an example in which the key tops 4 and the top cover 5 are firmly fixed to the operation surface side of the base sheet 33 via the resin film 32 is described, in the key sheet 101 of the common modification example, instead of the key tops 4, the top cover 5, and the resin film 32, a key top 102 having a single plate shape is firmly fixed to the operation surface side of the base sheet 33. A light blocking printed layer 103 is provided on the back surface of the key top 102, and further a transparent printed layer 104 covering the light blocking printed layer 103 is provided on the entire back surface of the key top 102.

Also, by doing so, the illumination of the display elements 20 can be controlled, and a more thinner key sheet 101 can be realized.

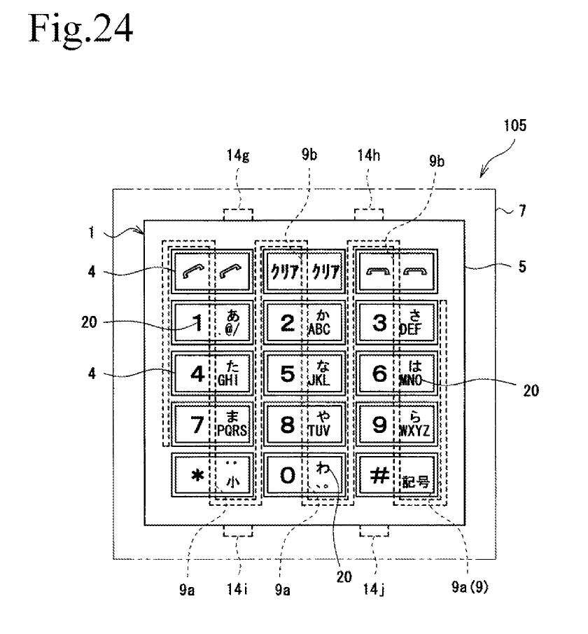

### Modification Example 2 Common to Each Embodiment [FIG. 24]

As shown in FIG. 5, in the push button switch 2 including the key sheet 1 of the first embodiment, the attenuation means 9 divides the illumination area along light emitting directions from the LEDs 14 which are light sources, and the display elements 20 are illuminated by direct light from the six LEDs from LED 14a to LED 14f arranged in an upper portion and a lower portion in FIG. 5. However, the number of the LEDs can be arbitrarily adjusted according to an appropriate illumination intensity desired for the display elements 20.

For example, as shown in FIG. 24, a push button switch 105 may be formed so that the display elements 20 are illuminated by direct light from the four LEDs from LED 14g to LED 14j arranged in an upper portion and a lower portion in FIG. 24 and reflected light (indirect light) of the direct light which is reflected by the attenuation means 9.

The characteristic configurations of each embodiment and each modification example described above can be applied to other embodiments.

### INDUSTRIAL APPLICABILITY

The present invention relates to an illumination type key sheet and a push button switch used as an operation unit of various electronic devices such a mobile communication device, an AV device, an in-vehicle electronic device, and an electric device. Therefore the present invention can be used in the information communication device industry, the home electronics industry, the in-vehicle electronic device industry, and related industries thereof.

### REFERENCE SIGNS LIST

1 key sheet (first embodiment)

2 push button switch

3 base sheet

4 key top

5 top cover
5a through hole

6 pusher sheet
6a resin film
6b pusher

7 housing

8 light guiding means
8a through hole

9 attenuation means
9a dividing portion
9b partition portion

10 diffusion layer

11 adhesive layer

12 circuit board

13 metal dome

14 LED (internal light source)
14a to 14j LED

15 key sheet (first modification example of first embodiment)

16 printed display layer
16a light blocking layer
16b light passing layer

17 diffusion layer

18 light reflecting layer (attenuation means)
18a dividing portion
18b partition portion

19 key sheet (second modification example of first embodiment)

20 display element

21 key sheet (second embodiment)

23 base sheet

29 attenuation means
29a dividing portion
29b partition portion

31 key sheet (third embodiment)

32 resin film

41 key sheet (fourth embodiment)

42 blindfold portion

44 key top
44a reception concave portion

45 top cover
45b reception concave portion through hole

47 key sheet (modification example of fourth embodiment)

51 key sheet (fifth embodiment)

52 resin film
52a reception concave portion

53 base sheet

56 pusher sheet
56a resin film
56b pusher
56c reception concave portion

59 attenuation means
59a dividing portion
59b partition portion
59c protrusion portion (blindfold portion)
59d light blocking elastic body

61 key sheet (sixth embodiment)

62 blindfold portion
62a tip portion

63 base sheet

71 key sheet (seventh embodiment)

73 base sheet

78 light guiding means
78a through hole

79 attenuation means
79a dividing portion
79b partition portion

81 key sheet (eighth embodiment)

82 resin film
82a light blocking printed layer (attenuation means)

83 base sheet

86 coating portion

87 key sheet (modification example of eighth embodiment)

89 attenuation means
89a dividing portion
89b partition portion
89c side surface coating portion
89d back surface coating portion
89e pusher portion

91 key sheet (ninth embodiment)

93 base sheet

94 key sheet (first modification example of ninth embodiment)

95 light color layer

96 key sheet (first modification example of ninth embodiment)

97 half deposition layer

99 attenuation means
99a dividing portion
99b partition portion
99c side surface coating portion
99d back surface coating portion
99e pusher portion

101 key sheet (modification example common to each embodiment)

102 operation plate

103 light blocking printed layer

104 transparent printed layer

105 push button switch

1. An illumination type key sheet which includes a base sheet formed of a light guiding sheet and light-transparent key tops firmly fixed to an operation surface side of the base sheet and in which a display element showing an operation function of a key top can be illuminated by backlight,
wherein the base sheet is a light guiding sheet which includes a light guiding means for transmitting light and an attenuation means for attenuating or reflecting light and in which the attenuation means divides the light guiding means into a plurality of illumination areas for transmitting light, and
a plurality of display elements showing a plurality of operation functions included in one key top are illuminated from an illumination area corresponding to each display element.

2. The illumination type key sheet according to claim 1, wherein the attenuation means divides a key top according to a plurality of illumination areas and the attenuation means divides the illumination area along a light emitting direction from a light source.

3. The illumination type key sheet according to claim 1, wherein a transparent resin film is provided on the operation surface side of the base sheet.

4. The illumination type key sheet according to claim 1, wherein a blindfold portion covering the attenuation means is provided on the operation surface side of the base sheet.

5. The illumination type key sheet according to claim 1, wherein a light color layer is provided between the light guiding means and the attenuation means.

6. The illumination type key sheet according to claim 1, wherein a resin film is provided between the light guiding means and the attenuation means.

7. A push button switch comprising:
an illumination type key sheet which includes a base sheet formed of a light guiding sheet and light-transparent key top firmly fixed to an operation surface side of the base sheet and in which a display element showing an operation function of a key top can be illuminated by backlight; and
a circuit board including a plurality of internal light sources,
wherein the base sheet is a light guiding sheet which includes a light guiding means for transmitting light and an attenuation means for attenuating or reflecting light and in which the attenuation means divides the light guiding means into a plurality of illumination areas for transmitting light, and
a plurality of display elements showing a plurality of operation functions included in one key top are illuminated from an illumination area corresponding to each display element.
